(19) United States
(12) Patent Application Publication
(10) Pub. No.: US 2020/0404668 A1
(43) Pub. Date: Dec. 24, 2020

(54) BASE STATION APPARATUS, TERMINAL APPARATUS, AND COMMUNICATION METHOD FOR THESE APPARATUSES

(71) Applicant: SHARP KABUSHIKI KAISHA, Sakai City, Osaka (JP)

(72) Inventors: OSAMU NAKAMURA, Sakai City, Osaka (JP); JUNGO GOTO, Sakai City, Osaka (JP); YASUHIRO HAMAGUCHI, Sakai City, Osaka (JP)

(21) Appl. No.: 16/954,882

(22) PCT Filed: Nov. 6, 2018
(86) PCT No.: PCT/JP2018/041129

§ 371 Date: Jun. 17, 2020

(30) Foreign Application Priority Data
Dec. 21, 2017 (JP) 2017-245078

(51) Int. Cl. H04W 72/04; H04B 7/06; H04W 76/11; H04L 1/18; H04L 1/00

(52) U.S. Cl. CPC H04W 72/0493; H04B 7/0626; H04W 72/042; H04W 72/0466; H04L 1/1819; H04L 1/0061; H04W 76/11

(57) ABSTRACT

A terminal apparatus for communicating with a base station apparatus, the terminal apparatus including: a radio receiving unit configured to receive a PDCCH for uplink transmission; a controller configured to decode the PDCCH; and a transmitter configured to transmit a PUSCH including semi-persistent CSI, wherein the controller receives a PDCCH including a CRC scrambled with an SP-CSI RNTI, the PDCCH includes at least a field related to an HARQ process number, and the controller validates the PDCCH in a case that at least the field related to the HARQ process number is a prescribed value.

### TECHNICAL FIELD

The present invention relates to a base station apparatus, a terminal apparatus, and a communication method for these apparatuses.

This application claims priority to JP 2017-245078 filed on Dec. 21, 2017, the contents of which are incorporated herein by reference.

### BACKGROUND ART

In the Long Term Evolution (LTE) communication system standardized by Third Generation Partnership Project (3GPP), in downlink, an adaptation modulation (Link adaptation, Rank adaptation) is applied that adaptively controls a coding rate, a modulation scheme, and a rank (the number of streams, the number of layers) according to a channel state. Adaptive modulation allows transmission at an appropriate transmission rate depending on channel quality. (NPL 1)

In order to perform adaptive modulation in the downlink, a base station apparatus needs to know a channel quality of a terminal apparatus, and determine a coding rate, a modulation scheme, or a rank in accordance with the channel quality. In a case of an FDD system, a base station apparatus transmits a reference signal, the terminal apparatus calculates the channel quality by using the received reference signal, and the terminal apparatus transmits the calculated channel quality to the base station apparatus. Transmitting the calculated channel quality to the base station apparatus by the terminal apparatus is referred to as Channel State Information (CSI) reporting in LTE. In LTE, CSI reporting is broadly divided into periodic CSI reporting and aperiodic CSI reporting. In periodic CSI reporting, the terminal apparatus basically periodically (regularly) transmits by using the Physical Uplink Control CHannel (PUCCH), which is a channel for transmitting control signals. On the other hand, in aperiodic CSI reporting, in a case that the base station apparatus needs CSI of a certain terminal apparatus, the base station apparatus transmits a signal of the Physical Downlink Control CHannel (PDCCH) to the terminal apparatus, and the terminal apparatus receiving the PDCCH transmits CSI by using the Physical Uplink Shared CHannel (PUSCH), which is a channel for transmitting information. The base station apparatus knows the channel quality of the terminal apparatus by the two CSI reporting described above, and uses the channel quality for the adaptive modulation.

In 3GPP, fifth generation mobile communication (New Radio (NR)) is being standardized, and in standardization, it is determined to employ semi-persistent CSI reporting in addition to periodic CSI reporting and aperiodic CSI reporting employed in LTE. In semi-persistent CSI reporting, a method using a PUCCH and a method using a PUSCH have been proposed. The method using the PUCCH is agreed to perform activation and deactivation of the SP-CSI reporting by using the MAC CE. On the other hand, in SP-CSI reporting using a PUSCH, CSI reporting is performed by using radio resources reserved in the SPS mechanism by using a method for reserving radio resources introduced in LTE as semi-persistent scheduling (SPS). (NPL 1, and NPL 2)

### CITATION LIST

### Non Patent Literature

NPL 1: Ericsson, “On UL Data Transmission Procedures”, R1-1721015.
NPL 2: NTT DOCOMO, “UL data transmission procedures”, R1-1720824.

### SUMMARY OF INVENTION

### Technical Problem

The SP-CSI reporting and SPS have the same basic mechanism, but one carries CSI by using a PUSCH, while the other carries information such as voice by using a PUSCH, so the details are different. Because of the inefficiency in a case of performing the same process, it is assumed that an appropriate configuration may be given for each.

An aspect of the present invention has been made in view of these circumstances, and an object of the present invention is to provide a base station apparatus, a terminal apparatus, and a communication method that perform efficient control related to SP-CSI reporting.

### Solution to Problem

To address the above-mentioned drawbacks, a base station apparatus, a terminal apparatus, and a communication method according to an aspect of the present invention are configured as follows.

(1) An aspect of the present invention is a terminal apparatus for communicating with a base station apparatus, the terminal apparatus including: a radio receiving unit configured to receive a PDCCH for uplink transmission; a controller configured to decode the PDCCH; and a transmitter configured to transmit a PUSCH including semi-persistent CSI, wherein the controller receives a PDCCH including a CRC scrambled with an SP-CSI RNTI, the PDCCH includes at least a field related to an HARQ process number, and the controller validates the PDCCH in a case that at least the field related to the HARQ process number is a prescribed value.

(2) In an aspect of the present invention, the PDCCH further includes at least a field related to a redundancy version, and the controller validates the PDCCH in a case that the field related to the redundancy version is a prescribed value.

(3) In an aspect of the present invention, the PDCCH is validated in a case that the PDCCH is a prescribed format.

(4) In an aspect of the present invention, the PDCCH includes a field for indicating one of multiple CSI reports.

(5) An aspect of the present invention is a base station apparatus for communicating with a terminal apparatus, the base station apparatus including: a downlink control signal generation unit configured to generate a PDCCH for uplink transmission; and a receiver configured to receive an SP-CSI, wherein the PDCCH includes at least a field related to an HARQ process number, and the downlink control signal generation unit configures at least the field related to the HARQ process number to a prescribed value, and further includes a CRC scrambled with an SP-CSI RNTI in the PDCCH.

### Advantageous Effects of Invention

According to one or more aspects of the present invention, the base station apparatus and the terminal apparatus can perform efficient control related to SP-CSI reporting.

### BRIEF DESCRIPTION OF DRAWINGS

FIG. 1 is a diagram illustrating a configuration example of a communication system 1 according to a first embodiment.

FIG. 2 is a diagram illustrating validation of a PDCCH for activating an SPS of LTE.

FIG. 3 is a diagram illustrating validation of a PDCCH for releasing the SPS of LTE.

FIG. 4 is a diagram illustrating an example of a configuration of a base station apparatus according to the first embodiment.

FIG. 5 is a diagram illustrating an example of a configuration of a terminal apparatus according to the first embodiment.

### DESCRIPTION OF EMBODIMENTS

A communication system according to the present embodiments includes a base station apparatus (a cell, a small cell, a serving cell, a component carrier, an eNodeB, a Home eNodeB, and a gNodeB) and a terminal apparatus (a terminal, a mobile terminal, and User Equipment (UE)). In the communication system, in a case of a downlink, the base station apparatus serves as a transmitting apparatus (a transmission point, a transmit antenna group, a transmit antenna port group, or a Tx/Rx Point (TRP)), and the terminal apparatus serves as a receiving apparatus (a reception point, a reception terminal, a receive antenna group, or a receive antenna port group). In a case of an uplink, the base station apparatus serves as a receiving apparatus, and the terminal apparatus serves as a transmitting apparatus. The communication system is also applicable to Device-to-Device (D2D) communication. In this case, the terminal apparatus serves both as a transmitting apparatus and as a receiving apparatus.

The communication system is not limited to data communication between the terminal apparatus and the base station apparatus, the communication involving human beings, but is also applicable to a form of data communication requiring no human intervention, such as Machine Type Communication (MTC), Machine-to-Machine (M2M) Communication, communication for Internet of Things (IoT), or Narrow Band-IoT (NB-IoT) (hereinafter referred to as MTC). In this case, the terminal apparatus serves as an MTC terminal. The communication system can use, in the uplink and the downlink, a multi-carrier transmission scheme, such as a Cyclic Prefix-Orthogonal Frequency Division Multiplexing (CP-OFDM). The communication system may use, in the uplink, a transmission scheme, such as a Discrete Fourier Transform Spread-Orthogonal Frequency Division Multiplexing (DFTS-OFDM, also referred to as an SC-FDMA). Note that although the following describes a case of using an OFDM transmission scheme in the uplink and the downlink, the transmission scheme is not limited to this and another transmission scheme is applicable.

The base station apparatus and the terminal apparatus according to the present embodiments can communicate in a frequency band for which an approval of use (license) has been obtained from the government of a country or region where a radio operator provides services, that is, a so-called licensed band, and/or in a frequency band for which no approval (license) from the government of the country or region is required, that is, a so-called unlicensed band.

According to the present embodiments, “X/Y” includes the meaning of “X or Y”. According to the present embodiments, “X/Y” includes the meaning of “X and Y”. According to the present embodiments, “X/Y” includes the meaning of “X and/or Y”.

### First Embodiment

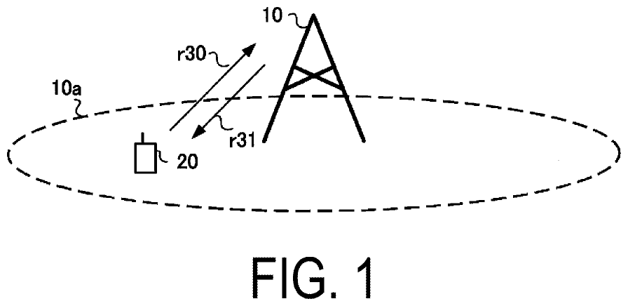

FIG. 1 is a diagram illustrating a configuration example of a communication system 1 according to the present embodiment. The communication system 1 according to the present embodiment includes a base station apparatus 10 and a terminal apparatus 20. Coverage 10a is a range (a communication area) in which the base station apparatus 10 can connect to the terminal apparatus 20 (coverage 10a is also referred to as a cell). Note that the base station apparatus 10 can accommodate multiple terminal apparatuses 20 in the coverage 10a.

In FIG. 1, an uplink radio communication r30 at least includes the following uplink physical channels. The uplink physical channels are used for transmitting information output from a higher layer.
Physical Uplink Control Channel (PUCCH)
Physical Uplink Shared Channel (PUSCH)
Physical Random Access Channel (PRACH)

The PUCCH is a physical channel that is used to transmit Uplink Control Information (UCI). The uplink control information includes a positive acknowledgement (ACK)/Negative acknowledgement (NACK) in response to downlink data (a Downlink transport block, a Medium Access Control Protocol Data Unit (MAC PDU), a Downlink-Shared Channel (DL-SCH), and a Physical Downlink Shared Channel (PDSCH). The ACK/NACK is also referred to as a Hybrid Automatic Repeat request ACKnowledgement (HARQ-ACK), a HARQ feedback, a HARQ response, or a signal indicating HARQ control information or a delivery confirmation.

The uplink control information includes a Scheduling Request (SR) used to request a PUSCH (Uplink-Shared Channel (UL-SCH)) resource for initial transmission. The scheduling request indicates that the UL-SCH resource for initial transmission is requested.

The uplink control information includes downlink Channel State Information (CSI). The downlink channel state information includes a Rank Indicator (RI) indicating a preferable spatial multiplexing order (the number of layers), a Precoding Matrix Indicator (PMI) indicating a preferable precoder, a Channel Quality Indicator (CQI) designating a preferable transmission rate, and the like. The PMI indicates a codebook determined by the terminal apparatus. The codebook is related to precoding of the physical downlink shared channel. The CQI can use an index (CQI index) indicative of a preferable modulation scheme (for example, QPSK, 16QAM, 64QAM, 256QAMAM, or the like), a preferable coding rate, and a preferable frequency utilization efficiency in a prescribed band. The terminal apparatus selects, from the CQI table, a CQI index considered to allow a transport block on the PDSCH to be received within a prescribed block error probability (for example, an error rate of 0.1). Note that the prescribed block error probability may be configured by RRC signaling.

The PUSCH is a physical channel used to transmit uplink data (an Uplink Transport Block, an Uplink-Shared Channel (UL-SCH)), and CP-OFDM or DFT-S-OFDM is applied as a transmission scheme. The PUSCH may be used to transmit the HARQ-ACK in response to the downlink data and/or the channel state information along with the uplink data. The PUSCH may be used to transmit only the channel state information. The PUSCH may be used to transmit only the HARQ-ACK and the channel state information.

The PUSCH is used to transmit radio resource control (Radio Resource Control (RRC)) signaling. The RRC signaling is also referred to as an RRC message/RRC layer information/an RRC layer signal/an RRC layer parameter/an RRC information element. The RRC signaling is information/signal processed in a radio resource control layer. The RRC signaling transmitted from the base station apparatus may be signaling common to multiple terminal apparatuses in a cell. The RRC signaling transmitted from the base station apparatus may be signaling dedicated to a certain terminal apparatus (also referred to as dedicated signaling). In other words, user equipment-specific (user equipment-unique) information is transmitted using the signaling dedicated to the certain terminal apparatus. The RRC message can include a UE Capability of the terminal apparatus. The UE Capability is information indicating a function supported by the terminal apparatus.

The PUSCH is used to transmit a Medium Access Control Element (MAC CE). The MAC CE is information/signal processed (transmitted) in a Medium Access Control layer. For example, a power headroom may be included in the MAC CE and may be reported via the physical uplink shared channel. In other words, a MAC CE field is used to indicate a level of the power headroom. The uplink data can include the RRC message and the MAC CE. The RRC signaling and/or the MAC CE is also referred to as a higher layer signal (higher layer signaling). The RRC signaling and/or the MAC CE are included in a transport block.

The PRACH is used to transmit a preamble used for random access. The PRACH is used to transmit a random access preamble. The PRACH is used for indicating the initial connection establishment procedure, the handover procedure, the connection re-establishment procedure, synchronization (timing adjustment) for uplink transmission, and the request for the PUSCH (UL-SCH) resource.

In the uplink radio communication, an Uplink Reference Signal (UL RS) is used as an uplink physical signal. The uplink physical signal is not used for transmission of information output from higher layers, but is used by the physical layer. The uplink reference signal includes a Demodulation Reference Signal (DMRS) and a Sounding Reference Signal (SRS). The DMRS is associated with transmission of the physical uplink-shared channel/physical uplink control channel. For example, the base station apparatus 10 uses the demodulation reference signal to perform channel estimation/channel compensation in a case of demodulating the physical uplink-shared channel/the physical uplink control channel.

The SRS is not associated with the transmission of the physical uplink shared channel/the physical uplink control channel. The base station apparatus 10 uses the SRS to measure an uplink channel state (CSI Measurement).

In FIG. 1, at least the following downlink physical channels are used in radio communication of the downlink r31. The downlink physical channels are used for transmitting information output from the higher layer.
Physical Broadcast Channel (PBCH)
Physical Downlink Control Channel (PDCCH)
Physical Downlink Shared Channel (PDSCH)

The PBCH is used for broadcasting a Master Information Block (MIB, a Broadcast Channel (BCH)) that is used commonly by the terminal apparatuses. The MIB is one of pieces of system information. For example, the MIB includes a downlink transmission bandwidth configuration and a System Frame number (SFN). The MIB may include information for indicating at least some of the number of the slot in which PBCH is transmitted, the number of the subframe in which PBCH is transmitted, and the number of the radio frame in which PBCH is transmitted.

The PDCCH is used to transmit Downlink Control Information (DCI). For the downlink control information, multiple formats based on applications (also referred to as DCI formats) are defined. The DCI format may be defined based on the type and the number of bits of the DCI constituting a single DCI format. Each format is used depending on the application. The downlink control information includes control information for downlink data transmission and control information for uplink data transmission. The DCI format for the downlink data transmission is also referred to as a downlink assignment (or downlink grant). The DCI format for the uplink data transmission is also referred to as an uplink grant (or uplink assignment).

A single downlink assignment is used for scheduling a single PDSCH in a single serving cell. The downlink grant may be used for at least scheduling of the PDSCH within the same slot as the slot in which the downlink grant has been transmitted. The downlink assignment includes downlink control information, such as a resource block allocation for the PDSCH, a Modulation and Coding Scheme (MCS) for the PDSCH, a NEW Data Indicator (NDI) for indicating initial transmission or retransmission, information for indicating the HARQ process number in the downlink, and a Redundancy version for indicating an amount of redundancy added to the codeword during error correction coding. The codeword is data after the error correcting coding. The downlink assignment may include a Transmission Power Control (TPC) command for the PUCCH and a TPC command for the PUSCH. The uplink grant may include a Repetition number for indicating the number of repetitions for transmission of the PUSCH. Note that the DCI format for each downlink data transmission includes information (fields) required for the application among the above-described information.

A single uplink grant is used for notifying the terminal apparatus of scheduling of a single PUSCH in a single serving cell. The uplink grant includes uplink control information, such as information on the resource block allocation for transmission of the PUSCH (resource block allocation and hopping resource allocation), information on the MCS for the PUSCH (MCS/Redundancy version), the number of cyclic shifts performed on the DMRS, information on retransmission of the PUSCH, a TPC command for the PUSCH, and a request for downlink Channel State Information (CSI)(CSI request). The uplink grant may include information for indicating the HARQ process number in the uplink, a Transmission Power Control (TPC) command for the PUCCH, and a TPC command for the PUSCH. Note that the DCI format for each uplink data transmission includes information (fields) required for the application among the above-described information.

The PDCCH is generated by adding a Cyclic Redundancy Check (CRC) to the downlink control information. In the PDCCH, CRC parity bits are scrambled with a prescribed identifier (also referred to as an exclusive OR operation, mask). The parity bits are scrambled with a Cell-Radio Network Temporary Identifier (C-RNTI), a Semi Persistent Scheduling (SPS) C-RNTI, a Temporary C-RNTI, a Paging (P)-RNTI, a System Information (SI)-RNTI, or a Random Access (RA)-RNTI. The C-RNTI and the SPS C-RNTI are identifiers for identifying a terminal apparatus within a cell. The Temporary C-RNTI is an identifier for identifying the terminal apparatus that has transmitted a random access preamble in a contention based random access procedure. The C-RNTI and the Temporary C-RNTI are used to control PDSCH transmission or PUSCH transmission in a single subframe. The SPS C-RNTI is used to periodically allocate a resource for the PDSCH or the PUSCH. The P-RNTI is used to transmit a paging message (Paging Channel (PCH)). The SI-RNTI is used to transmit the SIB, and the RA-RNTI is used to transmit a random access response (a message 2 in a random access procedure).

After correctly decoding the uplink DCI format, the terminal apparatus 20 performs semi-persistent CSI (SP-CSI) reporting on the PUSCH. The uplink DCI format includes DCI format 0_0 for fallback and DCI format 0_1 which is a configurable DCI format. The DCI format used for the activation of the SP-CSI reporting may be limited to only DCI format 0_0. Alternatively, both of DCI format 0_0 and DCI format 0_1 may be used. The release of the SP-CSI reporting may be limited to DCI format 0_0. The uplink DCI format includes one or multiple CSI reporting configuration indicators configured in a higher layer for a CSI measurement link and a CSI resource configuration. The SP-CSI reporting on PUSCH supports type 1 and type 2 CSI with granularity of wide band, partial band, and subband. The resource of the PUSCH is allocated semi-persistently by the uplink DCI format. For the SP-CSI reporting using the PUSCH, the activation of the SP-CSI reporting is performed by using the PDCCH, similar to SPS, and the deactivation (release) of the SP-CSI reporting is performed by using the PDCCH. The scrambling of the PDCCH at this time is performed by using an SP-CSI RNTI (or also referred to as an SP-CSI C-RNTI) rather than the RNTI described above. The controller 204 of the terminal apparatus 20 performs descrambling (cancellation of the scrambling) by using the SP-CSI RNTI. The PDCCH is validated only in a case that the CRC matches and further the value of the field in the DCI format is as prescribed, and the PDCCH is discarded in a case that the value of the field in the DCI format is other than the prescribed value even in a case that no error is detected in the CRC. In other words, in a case that all of the following conditions are satisfied, the terminal apparatus 20 validates the PDCCH for allocating the semi-persistent CSI reporting. The first is that CRC redundancy bits obtained for a PDCCH payload is scrambled with a semi-persistent CSI C-RNTI. The second is that a new data indicator field is configured to “0”. Here, in a case of a configurable DCI format, the new data indicator field refers to a field for a transport block that is validated. Details will be described below.

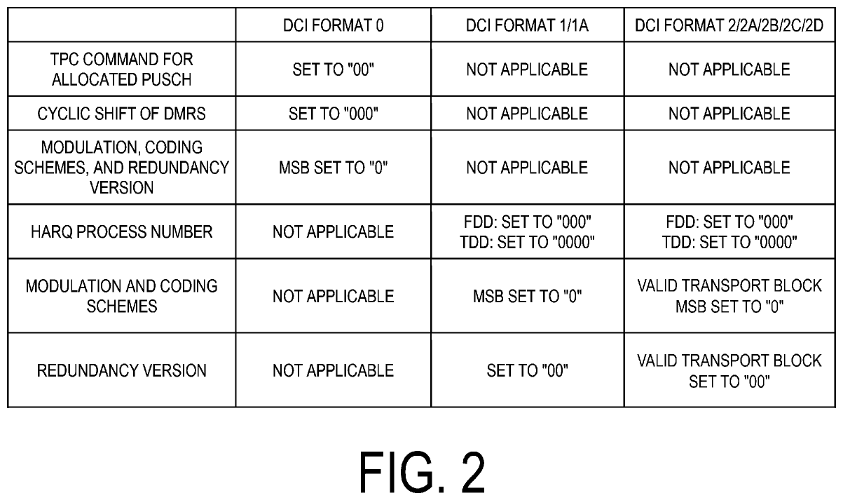

FIG. 2 illustrates validation conditions of the PDCCH for activating the SPS in LTE. Only DCI format 0 is a DCI format for uplink transmission. In the same manner as LTE, the PDCCH is scrambled with a CS-RNTI. As can be seen from the drawing, the TPC command for the allocated PUSCH is provided with a 2-bit region (field) in DCI format 0, and the downlink control signal generation unit 1064 (or the controller 104, the same is applied below) of the base station apparatus 10 configures the region to “00”. The cyclic shift of the DMRS (Cyclic shift DMRS) is provided with a 3-bit region in DCI format 0, and the downlink control signal generation unit 1064 of the base station apparatus 10 configures the region to “000”. The modulation scheme, the coding rate, and the redundancy version are provided with a 5-bit region in DCI format 0, and the downlink control signal generation unit 1064 of the base station apparatus 10 configures the most significant bit (MSB) of the region to “0”. Accordingly, in LTE, only 16 columns in the first half are used in the MCS table including 32 columns in the SPS. As a result, high transmission rates using 64QAM present only in the latter half of the table cannot be used in the SPS.

As described above, in the SPS in LTE, not only does no errors be detected in the CRC added to the DCI format, but further limiting information included in the DCI format reduces the probability of erroneous transmission due to decoding errors of the PDCCH.

Next, a description will be given of a case of grant-free (GF) type 2 in NR. In the case of the GF type 2, for the TPC command for the allocated PUSCH, the downlink control signal generation unit 1064 (or the controller 104) of the base station apparatus 10 configures the TPC command to “00”. Here, the value is not limited thereto, and may be used as a parameter for controlling the transmission power of the transmission of the GF type 2. On the other hand, information related to the antenna port (corresponding to information related to DMRS in LTE) is not limited. This is for enabling signal separation in the base station apparatus 10 by transmitting uplink signals of multiple terminal apparatuses (the terminal apparatus 20 and other terminal apparatuses) at different antenna ports. For the modulation scheme and the coding rate, a 5-bit region is provided in the DCI format, and the downlink control signal generation unit 1064 of the base station apparatus 10 configures the most significant bit (MSB) of the region to “0”. However, this is an example, and the number of bits configured to 0 may be changed by higher layer signaling (RRC signaling or the like) from the higher layer processing unit 102. In other words, the number of bits configured to 0 may be 0 or may be all (5 bits). Alternatively, it may be defined by the least significant bit (LSB) rather than the MSB. Furthermore, rather than higher layer signaling, a prescribed value may be shared by the base station apparatus 10 and the terminal apparatus 20 in a system. In NR, an MCS table including 256QAM and an MCS table not including 256QAM are going to be specified. At this time, for a case that the PUSCH for the SP-CSI reporting is allocated in the DCI format (DCI format 0_0 or DCI format 0_1) in which the CRC scrambled with the CS-RNTI is added. in a case that a higher parameter related to the MCS table is configured to “256QAM”, the terminal apparatus may use a field related to the modulation scheme and the coding rate in the DCI and a table not including 256QAM to determine the modulation scheme (modulation order) and the target coding rate used in the PUSCH. Here, the coding rate is calculated based on the number of resource elements included in the allocated radio resource, the amount of information of the CSI configured by the RRC signaling, and the modulation scheme (modulation order) used. Furthermore, in NR, different MCS tables are used depending on the waveform (CP-OFDM and DFT-S-OFDM), but in the PUSCH performing the SP-CSI reporting, the same MCS table may always be used regardless of the higher layer parameters. In NR, the HARQ process number is included in the DCI format in the uplink. Thus, the HARQ process number can be configured to a prescribed value.

The controller 204 of the terminal apparatus 20 performs descrambling (cancellation of the scrambling) by using the SPS C-RNTI. The PDCCH is validated only in a case that the CRC matches and further the value of the field in the DCI format is as prescribed, and the PDCCH is discarded in a case that the value of the field in the received DCI format is other than the prescribed value even in a case that no error is detected in the CRC.

Next, the case of the SP-CSI reporting will be described. With respect to the TPC command for the allocated PUSCH, the downlink control signal generation unit 1064 of the base station apparatus 10 configures the TPC command to “00”. Here, the value is not limited thereto, and may be used as a parameter for controlling the transmission power of the transmission of the SP-CSI reporting. On the other hand, for the information related to the antenna port (corresponding to the information related to the DMRS in LTE), the downlink control signal generation unit 1064 of the base station apparatus 10 configures the information all to 0. However, in the same manner as the GF type 2, in a case that separation is assumed in the base station apparatus 10, the base station apparatus 10 may be capable of configuring any value, without providing limitation. Next, for the modulation scheme and the coding rate, a 5-bit region is provided in the DCI format, but the number of bits to be transmitted is unchanged in the CSI reporting, so the modulation scheme may be fixed. In other words, the all bits are configured to “0” and the false detection rate of the PDCCH can be reduced. As the modulation scheme, a modulation scheme used for SP-CSI reporting may be defined to be, for example, QPSK (or may be 16QAM or the like) by a system, or may be configured by RRC signaling. Alternatively, any one of (π/2−) BPSK, QPSK, 16QAM, 64QAM, 256QAM may be selected by using one or more bits in a 5-bit field for MCS. For example, in the 5-bit field, in a case that the most significant three bits are 0, (π/2−) BPSK may be selected in a case that the least significant two bits are “00”, QPSK may be selected in a case that the lower two bits are “01”, 16QAM may be selected in a case that the lower two bits are “10”, and 64QAM may be selected in a case that the lower two bits are “11”. The valid least significant bit may be 1 bit. Alternatively, among the modulation scheme and coding rate specified in the MCS table of NR, it may be configured to ignore the coding rate and specify only the modulation scheme. In this case, the number of most significant bits configured to 0 may be a value other than 1.

Next, a field related to a redundancy version of the DCI format for validating SP-CSI reporting is described. In a case that the field related to the redundancy version is included in the DCI format, a prescribed value, for example, “00” is configured.

Next, a field related to an HARQ process number of the DCI format for validating SP-CSI reporting is described. In the SPS, in a case that there is an error in the detection of the PUSCH in the base station, retransmission based on the HARQ process number is performed. On the other hand, in a case that it is assumed that the HARQ is applied in a case that there is an error in the detection by the base station apparatus 10 in SP-CSI reporting using the PUSCH, the terminal apparatus 20 notifies the base station apparatus 10 of CSI which is not latest. Since transmitting old CSI has no meaning, the retransmission of CSI is less effective. Thus, the field related to the HARQ process number in the DCI format for validating the SP-CSI reporting is all configured to 0. In this way, the erroneous transmission rate of SP-CSI due to false detection of the PDCCH can be reduced.

Furthermore, the DCI format includes information that is not associated with activating the SP-CSI reporting. For example, information related to hopping (hopping flag) or a resource allocation type is included. The CSI reporting is basically a process for the base station apparatus 10 to understand whether or not the terminal apparatus 20 has a channel with high channel quality in local, and thus may be validated in a case that the field related to the hopping flag or the resource allocation type is all set to 0 in the PDCCH activating the SP-CSI reporting.

In the above description has been given assuming the DCI format for the fallback used during initial communication or reconnection. In NR, it is agreed to employ a configurable DCI format in addition to the DCI format for the fallback. In the configurable DCI format, the number of bits in the DCI format can be flexibly changed by the RRC signaling. For example, a field related to SP-CSI reporting may be provided in the DCI format. Information that is not associated with activating the SP-CSI reporting may be all configured to 0. Information that is not associated with activating the SP-CSI reporting includes information related to MIMO transmission. Even in a case that the information related to the PMI is included in the configurable DCI format, the SP-CSI is transmitted in rank 1 (single stream), so information related to the PMI may be all set to 0.

In a case that information related to the CSI request is included in the DCI format, the downlink control signal generation unit 1064 of the base station apparatus 10 configures all to 0. This is because the SP-CSI reporting itself is a function for transmitting CSI, and because the PDCCH is less dynamically transmitted as aperiodic CSI reporting is more performed, and thus the need to perform aperiodic CSI reporting by the PDCCH for performing the SP-CSI reporting is low.

In a case that the DCI format is a configurable DCI format, and a function for receiving and/or transmitting only in a part of the system band, which is referred to as Band Width Part (BEP), is specified in the DCI format, the downlink control signal generation unit 1064 of the base station apparatus 10 may configure all the field related to the BWP in the DCI format to a prescribed value, for example, 0, for the SP-CSI reporting.

In a case that all the field in the DCI format used are configured based on the above, the validation is achieved. In a case that the validation is achieved, the terminal apparatus 20 recognizes each received DCI information as valid semi-persistent activation or release. In a case that an uplink SP-CSI index field is present in the DCI format, the terminal apparatus 20 recognizes each received DCI information as valid semi-persistent activation or release only for the SPS configuration indicated by the uplink SP-CSI index field. Note that the same applies to not only the SP-CSI reporting, but also the GF type 2 (SPS). In a case that the validation is not achieved, the received DCI format is considered to be received as non-matching CRC by the terminal apparatus 20.

The controller 204 of the terminal apparatus 20 performs descrambling (cancellation of the scrambling) of the added CRC by using the SP-CSI RNTI. The PDCCH is validated only in a case that the CRC matches and further the value of the field in the DCI format is as prescribed, and the PDCCH is discarded in a case that the value of the field in the DCI format is other than the prescribed value even in a case that no error is detected in the CRC.

In this manner, the SP-CSI reporting is different from the GF type 2 (SPS) in the signal transmitted, and thus has different conditions of validating the PDCCH from the GF type 2 (SPS). As a result, appropriate conditions can be provided for the prescribed field of the DCI format, based on the transmission signal, and therefore, the false detection rate of the PDCCH can be reduced while performing flexible transmission.

Next, a case that the timings of the SP-CSI reporting by the SP-CSI RNTI and grant based data transmission by the C-RNTI match will be described. Since the base station apparatus 10 knows that the SP-CSI reporting is activated, it is conceivable that the base station apparatus 10 transmits the CSI to be transmitted by the SP-CSI reporting with the data signal by using the PUSCH allocated by the C-RNTI. Transmitting CSI together with the data signal is referred to as piggyback. In this manner, in a case that the timings of the SP-CSI reporting and the grant based data transmission by the C-RNTI match, transmission is performed by using the piggyback. However, in a case that the terminal is not capable of transmitting by piggyback or is not allowed to perform piggyback by the base station apparatus 10, grant based data transmission by the C-RNTI is prioritized. In other words, the terminal apparatus 20 drops the SP-CSI reporting.

Next, a case that the timings of the SP-CSI reporting by the SP-CSI RNTI and the GF access (type 1 and type 2) match will be described. The GF access allows transmission not to be performed in reserved radio resources. Therefore, it is expected that the radio resources reserved for the GF access has no capacity to include other information. In other words, the transmission using the piggyback requires a high coding rate transmission, and a prescribed communication quality is not satisfied. Thus, in a case that the timings of the SP-CSI reporting by the SP-CSI RNTI and the GF access match, the terminal apparatus 20 drops the transmission of the SP-CSI reporting and performs only the GF transmission.

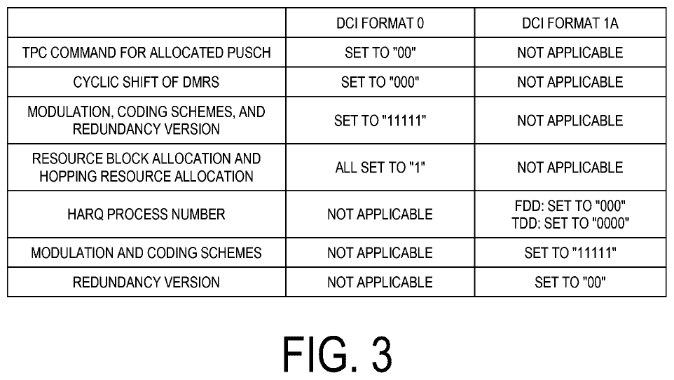

Next, a method for terminating the SP-CSI reporting by the SP-CSI RNTI will be described. Similar to the SPS of LTE, in order to terminate the SP-CSI reporting, the downlink control signal generation unit 1064 of the base station apparatus 10 transmits a DCI format (PDCCH) including the CRC configured to a prescribed value and further scrambled with the SP-CSI RNTI. The controller 204 of the terminal apparatus 20 descrambles the received PDCCH by the SP-CSI RNTI and validates the PDCCH in a case that a prescribed field in the DCI format is a prescribed value, and the controller 204 of the terminal apparatus 20 terminates the SP-CSI reporting. FIG. 3 illustrates fields of the DCI format configured by the base station apparatus 10 in releasing the SPS in LTE. Similar to FIG. 2, which illustrates activation, in a case that the DCI format of the PDCCH descrambled by the SPS C-RNTI does not satisfy the configuration in FIG. 3, the terminal apparatus 20 does not release (deactivate or clear) the SPS even in a case that no error is detected in CRC. The terminal apparatus performs similar processing in the SP-CSI reporting. In other words, the downlink control signal generation unit of the base station apparatus scrambles the PDCCH with the SP-CSI RNTI, and provides a prescribed configuration (constraint) for a prescribed field in the DCI format of the PDCCH. Here, in a case that the base station apparatus 10 manages multiple SP-CSI reportings, the controller (or the downlink control signal generation unit) of the base station apparatus allocates different HARQ process numbers for each CSI process. In a case of releasing the SP-CSI reporting, the controller (or the downlink control signal generation unit) of the base station apparatus configures the HARQ process number corresponding to the SP-CSI reporting to be released to the HARQ process number in the DCI format. The controller of the terminal apparatus 20 cancels the scrambling of the PDCCH by the SP-CSI RNTI, and releases the SP-CSI reporting in accordance with the value of the field of the HARQ process number in the DCI format. Note that the above description has been made of the SP-CSI reporting, but in the GF type 2, multiple GF (SPS) activations and releases may be performed in the same cell by performing the similar processing in a case that the SPS C-RNTI (also referred to as CS-RNTI) is used.

The PDSCH is used to transmit the downlink data (the downlink transport block, DL-SCH). The PDSCH is used to transmit a system information message (also referred to as a System Information Block (SIB)). Some or all of the SIBs can be included in the RRC message.

The PDSCH is used to transmit the RRC signaling. The RRC signaling transmitted from the base station apparatus may be common to the multiple terminal apparatuses in the cell (unique to the cell). That is, the information common to the user equipments in the cell is transmitted using the RRC signaling unique to the cell. The RRC signaling transmitted from the base station apparatus may be a message dedicated to a certain terminal apparatus (also referred to as dedicated signaling). In other words, user equipment-specific (user equipment-unique) information is transmitted by using the message dedicated to the certain terminal apparatus.

There are various RRC signaling transmitted by the PDSCH, for example, there is information related to SP-CSI reporting. The information related to SP-CSI reporting includes information for indicating which information to notify and which information to not notify, among a cycle for transmitting the SP-CSI, a time domain offset value in a symbol unit or a slot unit, information related to a rank (Rank Indicator (RI)), information related to channel quality (Channel Quality Indicator (CQI)), information related to precoding (Precoding Matrix Indicator, (PMI)), and the like. Furthermore, the information related to SP-CSI reporting may include information related to the designation of which information is to be quantized to what bits to be transmitted. The information related to SP-CSI reporting may notify, by RRC signaling, the transmission methods in a case that multiple codewords are present, how to transmit in a case of transmitting wide band CQI and/or subband CQI, and whether to transmit the absolute value CQI information or the differential CQI information, or the like.

In the GF type 1 and the GF type 2 (SPS), the number of repetitive transmissions is configured by the RRC. The number of repetitive transmissions is always configured to be 1 in the SP-CSI reporting, and is not configurable in the RRC signaling. For example, in a case that the GF type 2 and the RRC signaling of the SP-CSI reporting are common, the CSI reporting may be performed by assuming the number of repetitions to be 1, even in a case that the number of repetitions is configured for the GF type 2, in a case that the RRC signaling is used for the SP-CSI reporting.

The PDSCH is used to transmit the MAC CE. The RRC signaling and/or the MAC CE is also referred to as a higher layer signal (higher layer signaling). The PMCH is used to transmit multicast data (Multicast Channel (MCH)).

In the downlink radio communication in FIG. 1, a Synchronization signal (SS) and a Downlink Reference Signal (DL RS) are used as downlink physical signals. The downlink physical signals are not used for transmission of information output from the higher layers, but are used by the physical layer.

The synchronization signal is used for the terminal apparatus to take synchronization in the frequency domain and the time domain in the downlink. The downlink reference signal is used for the terminal apparatus to perform the channel estimation/channel compensation on the downlink physical channel. For example, the downlink reference signal is used to demodulate the PBCH, the PDSCH, and the PDCCH. The downlink reference signal can be used for the terminal apparatus to measure the downlink channel state (CSI measurement).

The downlink physical channel and the downlink physical signal are also collectively referred to as a downlink signal. The uplink physical channel and the uplink physical signal are also collectively referred to as an uplink signal. The downlink physical channel and the uplink physical channel are also collectively referred to as a physical channel. The downlink physical signal and the uplink physical signal are also collectively referred to as a physical signal.

The BCH, the UL-SCH, and the DL-SCH are transport channels. Channels used in the Medium Access Control (MAC) layer are referred to as transport channels. A unit of the transport channel used in the MAC layer is also referred to as a Transport Block (TB) or a MAC Protocol Data Unit (PDU). The transport block is a unit of data that the MAC layer delivers to the physical layer. In the physical layer, the transport block is mapped to a codeword, and coding processing and the like are performed for each codeword.

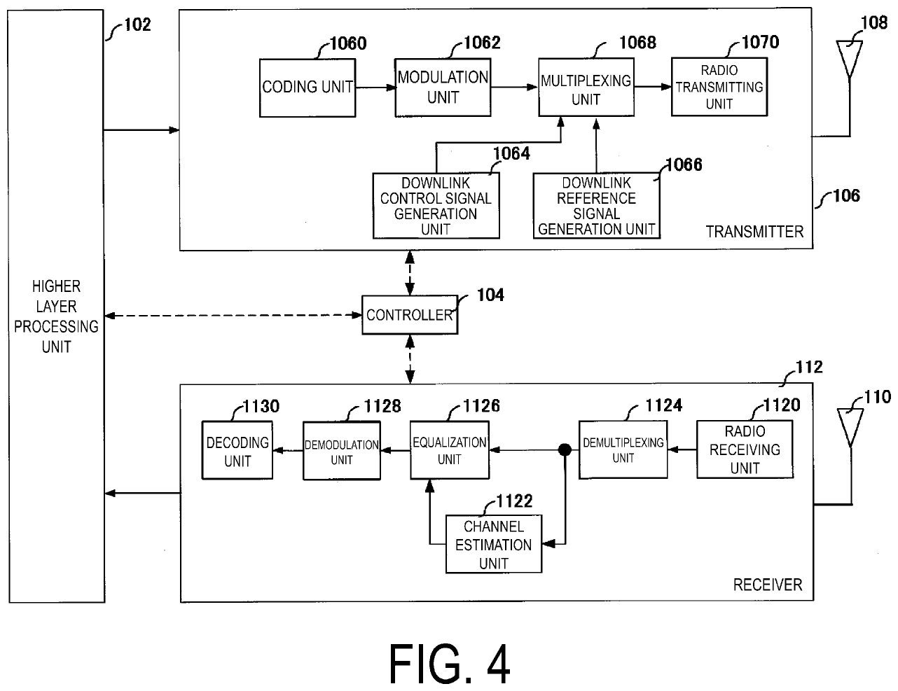

FIG. 4 is a schematic block diagram of a configuration of the base station apparatus 10 according to the present embodiment. The base station apparatus 10 includes a higher layer processing unit (higher layer processing step) 102, a controller (control step) 104, a transmitter (transmitting step) 106, a transmit antenna 108, a receive antenna 110, and a receiver (receiving step) 112. The transmitter 106 generates the physical downlink channel in accordance with a logical channel input from the higher layer processing unit 102. The transmitter 106 includes a coding unit (coding step) 1060, a modulation unit (modulating step) 1062, a downlink control signal generation unit (downlink control signal generating step) 1064, a downlink reference signal generation unit (downlink reference signal generating step) 1066, a multiplexing unit (multiplexing step) 1068, and a radio transmitting unit (radio transmitting step) 1070. The receiver 112 detects (demodulates, decodes, or the like) the physical uplink channel and inputs the content to the higher layer processing unit 102. The receiver 112 includes a radio receiving unit (radio receiving step) 1120, a channel estimation unit (channel estimating step) 1122, a demultiplexing unit (demultiplexing step) 1124, an equalization unit (equalizing step) 1126, a demodulation unit (demodulating step) 1128, and a decoding unit (decoding step) 1130.

The higher layer processing unit 102 performs processing on a higher layer than the physical layer, such as a Medium Access Control (MAC) layer, a Packet Data Convergence Protocol (PDCP) layer, a Radio Link Control (RLC) layer, or a Radio Resource Control (RRC) layer. The higher layer processing unit 102 generates information required to control the transmitter 106 and the receiver 112, and outputs the resultant information to the controller 104. The higher layer processing unit 102 outputs the downlink data (such as DL-SCH), the system information (MIB, SIB), and the like to the transmitter 106. Note that the DMRS configuration information may be notified to the terminal apparatus by using the system information (MIB or SIB), instead of the notification by using the higher layer such as RRC.

The higher layer processing unit 102 generates, or acquires from a higher node, the system information (a part of the MIB or the SIB) to be broadcasted. The higher layer processing unit 102 outputs the system information to be broadcasted to the transmitter 106 as BCH/DL-SCH. The MIB is allocated to the PBCH in the transmitter 106. The SIB is allocated to the PDSCH in the transmitter 106. The higher layer processing unit 102 generates, or acquires from a higher node, the system information (SIB) specific to the terminal apparatus. The SIB is allocated to the PDSCH in the transmitter 106.

The higher layer processing unit 102 configures various RNTIs for each terminal apparatus. The RNTI is used for encryption (scrambling) of the PDCCH, the PDSCH, and the like. The higher layer processing unit 102 outputs the RNTI to the controller 104/the transmitter 106/the receiver 112.

In a case that the downlink data (transport block, DL-SCH) allocated to the PDSCH, the system information specific to the terminal apparatus (System Information Block: SIB), the RRC message, the MAC CE, and the DMRS configuration information are not notified by using the system information, such as the SIB and the MIB, and the DCI, the higher layer processing unit 102 generates, or acquires from a higher node, the DMRS configuration information or the like and outputs the information generated or acquired to the transmitter 106. The DMRS configuration information may be configured separately for each of the uplink and the downlink, or may be inclusively configured. The higher layer processing unit 102 manages various kinds of configuration information of the terminal apparatus 20. Note that a part of the function of the radio resource control may be performed in the MAC layer or the physical layer.

The higher layer processing unit 102 receives information on the terminal apparatus, such as the function supported by the terminal apparatus (UE capability), from the terminal apparatus 20 (via the receiver 112). The terminal apparatus 20 transmits its own function to the base station apparatus 10 by a higher layer signal (RRC signaling). The information on the terminal apparatus includes information for indicating whether the terminal apparatus supports a prescribed function or information for indicating that the terminal apparatus has completed introduction and testing of the prescribed function. The information for indicating whether the prescribed function is supported includes information for indicating whether the introduction and testing of the prescribed function have been completed.

In a case that the terminal apparatus supports the prescribed function, the terminal apparatus transmits information (parameters) for indicating whether the prescribed function is supported. In a case that the terminal apparatus does not support the prescribed function, the terminal apparatus may be configured not to transmit information (parameters) for indicating whether the prescribed function is supported. In other words, whether the prescribed function is supported is notified by whether information (parameters) for indicating whether the prescribed function is supported is transmitted. Note that the information (parameters) for indicating whether the prescribed function is supported may be notified by using one bit of 1 or 0.

The higher layer processing unit 102 acquires the DL-SCH from the decoded uplink data (including the CRC) from the receiver 112. The higher layer processing unit 102 performs error detection on the uplink data transmitted by the terminal apparatus. For example, the error detection is performed in the MAC layer.

The controller 104 controls the transmitter 106 and the receiver 112 based on the various kinds of configuration information input from the higher layer processing unit 102/receiver 112. The controller 104 generates the downlink control information (DCI) based on the configuration information input from the higher layer processing unit 102/receiver 112, and outputs the generated downlink control information to the transmitter 106. For example, the controller 104 configures, based on the configuration information on the DMRS input from the higher layer processing unit 102/receiver 112 (whether the configuration is the DMRS configuration 1 or the DMRS configuration 2), the frequency allocation of the DMRS (an even subcarrier or an odd subcarrier in the case of DMRS configuration 1, and any of the zeroth to the second sets in the case of the DMRS configuration 2), and generates the DCI. With the DCI, in addition to the frequency allocation of the DMRS, information on the cyclic shift of the DMRS, a coding pattern of an Orthogonal Cover Code (OCC) in the frequency domain, a coding pattern of the OCC in the time domain in a case that DMRS symbols are configured across multiple OFDM symbols, and the like may be notified. In addition to the information on the DMRS, the DCI includes various kinds of information, such as information on the MCS and the frequency allocation.

The controller 104 determines the MCS of the PUSCH in consideration of channel quality information (CSI Measurement result) measured by the channel estimation unit 1122. The controller 104 determines an MCS index corresponding to the MCS of the PUSCH. The controller 104 includes, in the uplink grant, the MCS index determined.

The transmitter 106 generates the PBCH, the PDCCH, the PDSCH, the downlink reference signal, and the like in accordance with the signal input from the higher layer processing unit 102/controller 104. The coding unit 1060 performs encoding (including repetition) using block code, convolutional code, turbo code, polar coding, LDPC code, or the like on the BCH, the DL-SCH, and the like input from the higher layer processing unit 102 by using a predetermined coding scheme/a coding scheme determined by the higher layer processing unit 102. The coding unit 1060 performs puncturing on the coded bits based on the coding rate input from the controller 104. The modulation unit 1062 performs data modulation on the coded bits input from the coding unit 1060 by using a predetermined modulation scheme (modulation order)/a modulation scheme (modulation order) input from the controller 104, such as the BPSK, QPSK, 16QAM, 64QAM, or 256QAM. The modulation order is based on the MCS index selected by the controller 104.

The downlink control signal generation unit 1064 adds the CRC to the DCI input from the controller 104. The downlink control signal generation unit 1064 encrypts (scrambles) the CRC by using the RNTI. Furthermore, the downlink control signal generation unit 1064 performs QPSK modulation on the DCI to which the CRC is added, and generates the PDCCH. The downlink reference signal generation unit 1066 generates a sequence known to the terminal apparatus as a downlink reference signal. The known sequence is determined by a predetermined rule based on a physical cell identity for identifying the base station apparatus 10 and the like.

The multiplexing unit 1068 multiplexes the PDCCHs/downlink reference signals/modulation symbols of the respective channels input from the modulation unit 1062. In other words, the multiplexing unit 1068 maps the PDCCHs/downlink reference signals/modulation symbols of the respective channels to the resource elements. The resource elements to which the mapping is performed are controlled by downlink scheduling input from the controller 104. The resource element is the minimum unit of a physical resource including one OFDM symbol and one subcarrier. Note that, in a case of performing MIMO transmission, the transmitter 106 includes the coding units 1060 and the modulation units 1062. Each of the number of the coding units 1060 and the number of the modulation units 1062 is equal to the number of layers. In this case, the higher layer processing unit 102 configures the MCS for each transport block in each layer.

The radio transmitting unit 1070 performs Inverse Fast Fourier Transform (IFFT) on the multiplexed modulation symbols and the like to generate OFDM symbols. The radio transmitting unit 1070 adds cyclic prefixes (CPs) to the OFDM symbols to generate a baseband digital signal. Furthermore, the radio transmitting unit 1070 converts the digital signal into an analog signal, removes unnecessary frequency components from the analog signal by filtering, performs up-conversion to a signal of a carrier frequency, performs power amplification, and outputs the resultant signal to the transmit antenna 108 for transmission.

In accordance with an indication from the controller 104, the receiver 112 detects (separates, demodulates, and decodes) the reception signal received from the terminal apparatus 20 through the receive antenna 110, and inputs the decoded data to the higher layer processing unit 102/controller 104. The radio receiving unit 1120 converts the uplink signal received through the receive antenna 110 into a baseband signal by down-conversion, removes unnecessary frequency components from the baseband signal, controls an amplification level such that a signal level is suitably maintained, performs orthogonal demodulation based on an in-phase component and an orthogonal component of the received signal, and converts the resulting orthogonally-demodulated analog signal into a digital signal. The radio receiving unit 1120 removes a part corresponding to the CP from the converted digital signal. The radio receiving unit 1120 performs Fast Fourier Transform (FFT) on the signal from which the CPs have been removed, and extracts a signal in the frequency domain. The signal in the frequency domain is output to the demultiplexing unit 1124.

The demultiplexing unit 1124 demultiplexes the signals input from the radio receiving unit 1120 into signals, such as the PUSCH, the PUCCH, and the uplink reference signal, based on uplink scheduling information (such as uplink data channel allocation information) input from the controller 104. The uplink reference signal resulting from the demultiplexing is input to the channel estimation unit 1122. The PUSCH and PUCCH resulting from the demultiplexing are output to the equalization unit 1126.

The channel estimation unit 1122 uses the uplink reference signal to estimate a frequency response (or a delay profile). The result of frequency response in the channel estimation for demodulation is input to the equalization unit 1126. The channel estimation unit 1122 measures the uplink channel condition (measures a Reference Signal Received Power (RSRP), a Reference Signal Received Quality (RSRQ), and a Received Signal Strength Indicator (RSSI)) by using the uplink reference signal. The measurement of the uplink channel state is used to determine the MCS for the PUSCH and the like.

The equalization unit 1126 performs processing to compensate for an influence in a channel based on the frequency response input from the channel estimation unit 1122. As a method for the compensation, any existing channel compensation, such as a method of multiplying an MMSE weight or an MRC weight and a method of applying an MLD, is applicable. The demodulation unit 1128 performs demodulation processing based on the information on a predetermined modulation scheme/modulation scheme indicated by the controller 104.

The decoding unit 1130 performs decoding processing on the output signal from the demodulation unit based on the information on a predetermined coding rate/coding rate indicated by the controller 104. The decoding unit 1130 inputs the decoded data (such as the UL-SCH) to the higher layer processing unit 102.

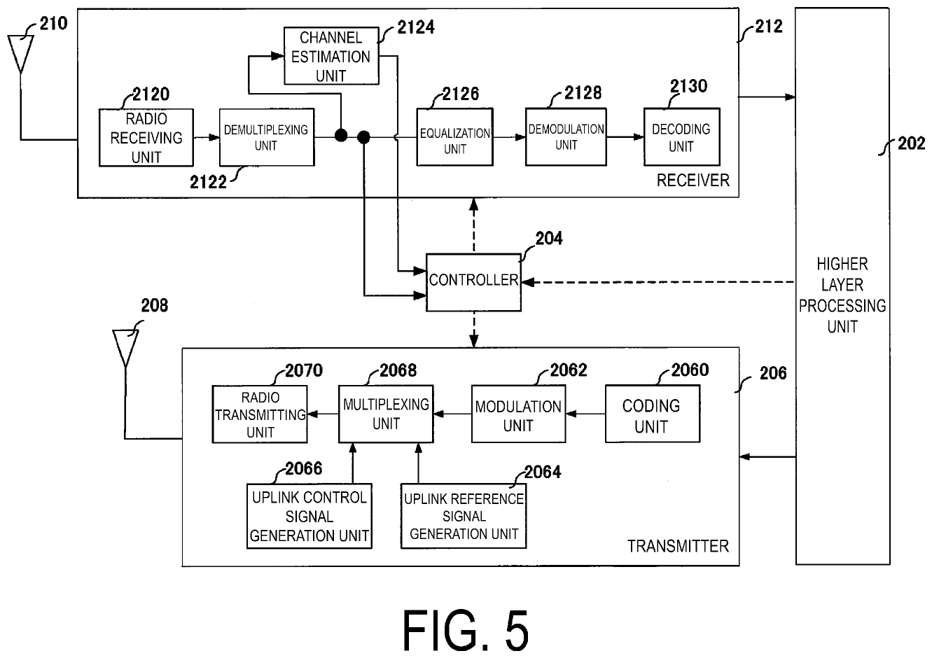

FIG. 5 is a schematic block diagram illustrating a configuration of the terminal apparatus 20 according to the present embodiment. The terminal apparatus 20 includes a higher layer processing unit (higher layer processing step) 202, a controller (control step) 204, a transmitter (transmitting step) 206, a transmit antenna 208, a receive antenna 210, and a receiver (receiving step) 212.

The higher layer processing unit 202 performs processing of the medium access control (MAC) layer, the packet data convergence protocol (PDCP) layer, the radio link control (RLC) layer, and the radio resource control (RRC) layer. The higher layer processing unit 202 manages various kinds of configuration information of the terminal apparatus itself. The higher layer processing unit 202 notifies the base station apparatus 10 of information for indicating terminal apparatus functions supported by the terminal apparatus itself (UE Capability) via the transmitter 206. The higher layer processing unit 202 notifies the UE Capability by RRC signaling.

The higher layer processing unit 202 acquires the decoded data, such as the DL-SCH and the BCH, from the receiver 212. The higher layer processing unit 202 generates the HARQ-ACK from a result of the error detection of the DL-SCH. The higher layer processing unit 202 generates the SR. The higher layer processing unit 202 generates the UCI including the HARQ-ACK/SR/CSI (including the CQI report). In a case that the DMRS configuration information is notified by the higher layer, the higher layer processing unit 202 inputs the information on the DMRS configuration to the controller 204. The higher layer processing unit 202 inputs the UCI and the UL-SCH to the transmitter 206. Note that some functions of the higher layer processing unit 202 may be included in the controller 204.

The controller 204 interprets the downlink control information (DCI) received via the receiver 212. The controller 204 controls the transmitter 206 in accordance with PUSCH scheduling/MCS index/Transmission Power Control (TPC), and the like acquired from the DCI for uplink transmission. The controller 204 controls the receiver 212 in accordance with the PDSCH scheduling/the MCS index and the like acquired from the DCI for downlink transmission. Furthermore, the controller 204 identifies the frequency allocation of the DMRS according to the information on the frequency allocation of the DMRS included in the DCI for downlink transmission and the DMRS configuration information input from the higher layer processing unit 202.

The transmitter 206 includes a coding unit (coding step) 2060, a modulation unit (modulating step) 2062, an uplink reference signal generation unit (uplink reference signal generating step) 2064, an uplink control signal generation unit (uplink control signal generating step) 2066, a multiplexing unit (multiplexing step) 2068, and a radio transmitting unit (radio transmitting step) 2070.

In accordance with the control by the controller 204 (in accordance with the coding rate calculated based on the MCS index), the coding unit 2060 codes the uplink data (UL-SCH) input from the higher layer processing unit 202 by convolutional coding, block coding, turbo coding, or the like.

The modulation unit 2062 modulates the coded bits input from the coding unit 2060 (generates modulation symbols for the PUSCH) by a modulation scheme indicated from the controller 204/modulation scheme predetermined for each channel, such as BPSK, QPSK, 16QAM, 64QAM, and 256QAM.

The uplink reference signal generation unit 2064 generates a sequence determined from a predetermined rule (formula), based on a physical cell identity (PCI), which is also referred to as a Cell ID, or the like, for identifying the base station apparatus 10, a bandwidth in which the uplink reference signals are mapped, a cyclic shift, parameter values to generate the DMRS sequence, further the frequency allocation, and the like, in accordance with an indication by the controller 204.

In accordance with the indication from the controller 204, the uplink control signal generation unit 2066 encodes the UCI, performs the BPSK/QPSK modulation, and generates modulation symbols for the PUCCH.

In accordance with the uplink scheduling information from the controller 204 (transmission interval in the SPS for the uplink included in the RRC message, resource allocation included in the DCI, and the like), the multiplexing unit 2068 multiplexes the modulation symbols for the PUSCH, the modulation symbols for the PUCCH, and the uplink reference signals for each transmit antenna port (in other words, the respective signals are mapped to the resource elements).

The radio transmitting unit 2070 performs Inverse Fast Fourier Transform (IFFT) on the multiplexed signals to generate OFDM symbols. The radio transmitting unit 2070 adds CPs to the OFDM symbols to generate a baseband digital signal. Furthermore, the radio transmitting unit 2070 converts the baseband digital signal into an analog signal, removes unnecessary frequency components from the analog signal, converts the signal into a signal of a carrier frequency by up-conversion, performs power amplification, and transmits the resultant signal to the base station apparatus 10 via the transmit antenna 208.

The receiver 212 includes a radio receiving unit (radio receiving step) 2120, a demultiplexing unit (demultiplexing step) 2122, a channel estimation unit (channel estimating step) 2144, an equalization unit (equalizing step) 2126, a demodulation unit (demodulating step) 2128, and a decoding unit (decoding step) 2130.

The radio receiving unit 2120 converts the downlink signal received through the receive antenna 210 into a baseband signal by down-conversion, removes unnecessary frequency components from the baseband signal, controls an amplification level such that a signal level is suitably maintained, performs orthogonal demodulation based on an in-phase component and an orthogonal component of the received signal, and converts the resulting orthogonally-demodulated analog signal into a digital signal. The radio receiving unit 2120 removes a part corresponding to the CP from the digital signal resulting from the conversion, performs the FFT on the signal from which the CP has been removed, and extracts a signal in the frequency domain.

The demultiplexing unit 2122 separates the extracted signal in the frequency domain into the downlink reference signal, the PDCCH, the PDSCH, and the PBCH. A channel estimation unit 2124 uses the downlink reference signal (such as the DM-RS) to estimate a frequency response (or delay profile). The result of frequency response in the channel estimation for demodulation is input to the equalization unit 1126. The channel estimation unit 2124 measures the uplink channel state (measures a Reference Signal Received Power (RSRP), a Reference Signal Received Quality (RSRQ), a Received Signal Strength Indicator (RSSI), and a Signal to Interference plus Noise power Ratio (SINR)) by using the downlink reference signal (such as the CSI-RS). The measurement of the downlink channel state is used to determine the MCS for the PUSCH and the like. The measurement result of the downlink channel state is used to determine the CQI index and the like.

The equalization unit 2126 generates an equalization weight based on an MMSE criterion, from the frequency response input from the channel estimation unit 2124. The equalization unit 2126 multiplies the input signal (the PUCCH, the PDSCH, the PBCH, and the like) from the demultiplexing unit 2122 by the equalization weight. The demodulation unit 2128 performs demodulation processing based on information of the predetermined modulation order/the modulation order indicated by the controller 204.

The decoding unit 2130 performs decoding processing on the output signal from the demodulation unit 2128 based on information of the predetermined coding rate/the coding rate indicated by the controller 204. The decoding unit 2130 inputs the decoded data (such as the DL-SCH) to the higher layer processing unit 202.

A program running on an apparatus according to an aspect of the present invention may serve as a program that controls a Central Processing Unit (CPU) and the like to cause a computer to operate in such a manner as to realize the functions of the above-described embodiments according to an aspect of the present invention. Programs or the information handled by the programs are temporarily read into a volatile memory, such as a Random Access Memory (RAM) while being processed, or stored in a non-volatile memory, such as a flash memory, or a Hard Disk Drive (HDD), and then read by the CPU to be modified or rewritten, as necessary.

Note that the apparatuses in the above-described embodiments may be partially enabled by a computer. In that case, a program for realizing the functions of the embodiments may be recorded on a computer readable recording medium. This configuration may be realized by causing a computer system to read the program recorded on the recording medium for execution. It is assumed that the “computer system” refers to a computer system built into the apparatuses, and the computer system includes an operating system and hardware components such as a peripheral device. The “computer-readable recording medium” may be any of a semiconductor recording medium, an optical recording medium, a magnetic recording medium, and the like.

Moreover, the “computer-readable recording medium” may include a medium that dynamically retains a program for a short period of time, such as a communication line that is used for transmission of the program over a network such as the Internet or over a communication line such as a telephone line, and may also include a medium that retains a program for a fixed period of time, such as a volatile memory within the computer system for functioning as a server or a client in such a case. The program may be configured to realize some of the functions described above, and also may be configured to be capable of realizing the functions described above in combination with a program already recorded in the computer system.

Each functional block or various characteristics of the apparatuses used in the above-described embodiments may be implemented or performed on an electric circuit, that is, typically an integrated circuit or multiple integrated circuits. An electric circuit designed to perform the functions described in the present specification may include a general-purpose processor, a Digital Signal Processor (DSP), an Application Specific Integrated Circuit (ASIC), a Field Programmable Gate Array (FPGA), or other programmable logic devices, discrete gates or transistor logic, discrete hardware components, or a combination thereof. The general-purpose processor may be a microprocessor or may be a processor of known type, a controller, a micro-controller, or a state machine instead. The above-mentioned electric circuit may include a digital circuit, or may include an analog circuit. In a case that with advances in semiconductor technology, a circuit integration technology appears that replaces the present integrated circuits, it is also possible to use an integrated circuit based on the technology.

Note that the invention of the present patent application is not limited to the above-described embodiments. In the embodiment, apparatuses have been described as an example, but the invention of the present application is not limited to these apparatuses, and is applicable to a terminal apparatus or a communication apparatus of a fixed-type or a stationary-type electronic apparatus installed indoors or outdoors, for example, an AV apparatus, a kitchen apparatus, a cleaning or washing machine, an air-conditioning apparatus, office equipment, a vending machine, and other household apparatuses.

The embodiments of the present invention have been described in detail above referring to the drawings, but the specific configuration is not limited to the embodiments and includes, for example, an amendment to a design that falls within the scope that does not depart from the gist of the present invention. Various modifications are possible within the scope of one aspect of the present invention defined by claims, and embodiments that are made by suitably combining technical means disclosed according to the different embodiments are also included in the technical scope of the present invention. A configuration in which constituent elements, described in the respective embodiments and having mutually the same effects, are substituted for one another is also included in the technical scope of the present invention.

### INDUSTRIAL APPLICABILITY

An aspect of the present invention can be preferably used in a base station apparatus, a terminal apparatus, and a communication method. An aspect of the present invention can be utilized, for example, in a communication system, communication equipment (for example, a cellular phone apparatus, a base station apparatus, a wireless LAN apparatus, or a sensor device), an integrated circuit (for example, a communication chip), or a program.

### REFERENCE SIGNS LIST

10 Base station apparatus
20 Terminal apparatus
10a Coverage within which base station apparatus 10 is connectable to terminal apparatus
102 Higher layer processing unit
104 Controller
106 Transmitter
108 Transmit antenna
110 Receive antenna
112 Receiver
1060 Coding unit
1062 Modulation unit
1064 Downlink control signal generation unit
1066 Downlink reference signal generation unit
1068 Multiplexing unit
1070 Radio transmitting unit
1120 Radio receiving unit
1122 Channel estimation unit
1124 Demultiplexing unit
1126 Equalization unit
1128 Demodulation unit
1130 Decoding unit
202 Higher layer processing unit
204 Controller
206 Transmitter
208 Transmit antenna
210 Receive antenna
212 Receiver
2060 Coding unit
2062 Modulation unit
2064 Uplink reference signal generation unit
2066 Uplink control signal generation unit
2068 Multiplexing unit
2070 Radio transmitting unit
2120 Radio receiving unit
2122 Demultiplexing unit
2124 Channel estimation unit
2126 Equalization unit
2128 Demodulation unit
2130 Decoding unit

1. A terminal apparatus for communicating with a base station apparatus, the terminal apparatus comprising:
a radio receiving unit configured to receive a PDCCH for uplink transmission;
a controller configured to decode the PDCCH; and
a transmitter configured to transmit a PUSCH including semi-persistent CSI, wherein
the controller receives a PDCCH including a CRC scrambled with an SP-CSI RNTI,
the PDCCH includes at least a field related to an HARQ process number, and
the controller validates the PDCCH in a case that at least the field related to the HARQ process number is a prescribed value.

2. The terminal apparatus according to claim 1, wherein
the PDCCH further includes at least a field related to a redundancy version, and
the controller validates the PDCCH in a case that the field related to the redundancy version is a prescribed value.

3. The terminal apparatus according to claim 1, wherein
the PDCCH is validated in a case that the PDCCH is a prescribed format.

4. The terminal apparatus according to claim 1, wherein
the PDCCH includes a field for indicating one of multiple CSI reports.

5. A base station apparatus for communicating with a terminal apparatus, the base station apparatus comprising:
a downlink control signal generation unit configured to generate a PDCCH for uplink transmission; and
a receiver configured to receive an SP-CSI, wherein
the PDCCH includes at least a field related to an HARQ process number, and
the downlink control signal generation unit configures at least the field related to the HARQ process number to a prescribed value, and further includes a CRC scrambled with an SP-CSI RNTI in the PDCCH.
